(19) United States
(12) Patent Application Publication
(10) Pub. No.: US 2013/0044034 A1
(43) Pub. Date: Feb. 21, 2013

(54) EARPHONE ANTENNA DEVICE

(71) Applicants: Tae-IL KIM, Gyeonggi-do (KR); In-Sung CHO, Gyeonggi-do (KR); Jae-Gon GHIM, Gyeonggi-do (KR)

(72) Inventors: Tae-IL KIM, Gyeonggi-do (KR); In-Sung CHO, Gyeonggi-do (KR); Jae-Gon GHIM, Gyeonggi-do (KR)

(73) Assignee: SAMSUNG ELECTRONICS CO., LTD., Gyeonggi-do (KR)

(21) Appl. No.: 13/584,925

(22) Filed: Aug. 14, 2012

(30) Foreign Application Priority Data
Aug. 17, 2011 (KR) 10-2011-0081913

(51) Int. Cl. H01Q 1/44

(52) U.S. Cl. 343/720

(57) ABSTRACT

Provided is an earphone antenna device configured to use an antenna line in lieu of a ground line in a specified area of an earphone antenna cable, and more specifically the earphone antenna device o includes a first cable provided between an ear jack and an junction to have embedded therein an antenna line used without comprising the earth line, a second cable embedded therein a plurality of earth lines, wherein a bead portion embedded in the junction to electrically couple the antenna line and the plural earth lines.

### CLAIM OF PRIORITY

This application claims the benefit under 35 U.S.C. §119 of a Korean Patent Application filed in the Korean Intellectual Property Office on Aug. 17, 2011 and assigned Serial No. 10-2011-0081913, the entire disclosure of which is hereby incorporated by reference.

### BACKGROUND OF THE INVENTION

1. Field of the Invention

The present invention relates to an earphone antenna having an antenna line and an earth line as an earphone antenna cable.

2. Description of the Related Art

Generally, an earphone is coupled to an audio output jack of a portable communication device, a radio set, a Portable Multimedia Player (PMP), an MP3 player, a cassette player, a Compact Disc (CD) player, a Digital Multimedia Broadcasting (DMB) player, a portable terminal, etc., to transmit an audio signal to an earphone for replay.

Recently, as terrestrial DMB and satellite DMB functions have been added to portable communication devices, users on the move can now enjoy TV broadcasting through the portable communication devices.

The DMB technology receives electric waves output from a satellite or a broadcasting station, decodes them, and outputs video and audio. Therefore, a separate broadcast receiving antenna capable of receiving a signal in the form of electric waves has to be provided. To this end, the broadcast receiving antenna has to be inconveniently carried at all times with the portable communication device.

To solve the foregoing problem, an earphone antenna in which an antenna is embedded in an earphone cable has been developed.

Referring to FIG. 1, a conventional earphone antenna 1 includes an ear jack 2 electrically connected with a portable communication device (not shown), left and right speaker devices 3 and 4, a microphone device 5, an earphone cable 6 having an antenna line embedded therein, and a junction 7.

The earphone cable 6 includes a single cable from the ear jack 2 to the junction 7, and two cables from the junction 7 to the left and right speaker devices 3 and 4 for connection between the left and right speaker devices 3 and 4.

As illustrated in FIGS. 2 and 3, the earphone antenna 1 includes a microphone line 8, left and right speaker lines 9 and 10, earphone signal earth lines 11 and 12, and the antenna line 13 surrounding the lines 8, 9, 10, 11, and 12.

Related structures of the conventional earphone antenna have been disclosed in Japanese Patent Registration No. 4424144 (Dec. 18, 2009).

However, the conventional earphone antenna includes an earphone signal earth line in adjacent to an antenna line, such that noise signals induced to the earth lines are delivered to the antenna line, thus degrading the performance of the antenna.

Moreover, when the microphone line, the left and right speaker lines, the earphone signal earth lines, and the antenna line are covered in a single cable, the diameter of the cable increases, thereby causing the design of a product to be unattractive, increasing the manufacturing cost of the product, and degrading the flexibility of the product which in turn degrades the wearing sense of the product. Furthermore, the volume of the earphone cable increases, so there is a problem that it requires a large storage space according to the increased volume of the earphone cable.

Accordingly, there is a need for a device allowing the antenna line to be used in place of the earth line but without using the earth line in the earphone antenna cable.

### SUMMARY OF THE INVENTION

Accordingly, an aspect of the present invention is to provide an earphone antenna device configured to use an antenna line in place of an earth line and without using the earth line on an earphone antenna cable to remove a need for the conventional earphone signal earth line in the earphone antenna cable, thereby reducing noises, which have been generated between the antenna line and the conventional earphone signal earth line, and improving the antenna performance of a product.

Another aspect of the present invention is to provide an earphone antenna device configured to use an antenna line in place of an earth line without using the earth line on an earphone antenna cable to remove a need for the conventional earphone signal earth line in the earphone antenna cable, thereby reducing the number of parts of a product, thus cutting down the unit cost of manufacturing of the product and making the design of the product elegant through reduction of the thickness of the earphone antenna cable, and contributing to the slimness and miniaturization of the product.

According to an aspect of the present invention, there is provided an earphone antenna device including an ear jack, a junction, left and right speaker phones, a microphone device, first and second cables, and a bead portion. The ear jack is electrically connected with an antenna line by soldering, and is electrically connected with left and right speaker lines and a microphone line. The junction is configured to separate the left and right speaker phones to the left and right sides. The microphone device is provided in a cable of the right speaker phone.

The first cable is provided between the ear jack and the junction to have embedded therein an antenna line used in place of an earth line without comprising the earth line. The second cable is provided between the junction and the left and right speaker phones to have embedded therein a plurality of earth lines. The bead portion is embedded in the junction to electrically connect the antenna line and the earth lines.

According to another aspect of the present invention, there is provided an earphone antenna device including a cable having embedded therein an antenna line which substitutes for an earth line without comprising the earth line and a bead portion provided on the cable to electrically connect ground lines and the antenna line which are provided in the cable of the earphone antenna device.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 illustrates a conventional earphone antenna;

FIG. 2 is a cross-sectional view taken along a line A-A′ of FIG. 1;

FIG. 3 illustrates the inside of a conventional earphone antenna;

FIG. 4 illustrates an ear phone device according to an embodiment of the present invention;

FIG. 5 is a cross-sectional view taken along a line B-B′ of FIG. 4; and

FIG. 6 illustrates the inside of an earphone antenna device according to an embodiment of the present invention.

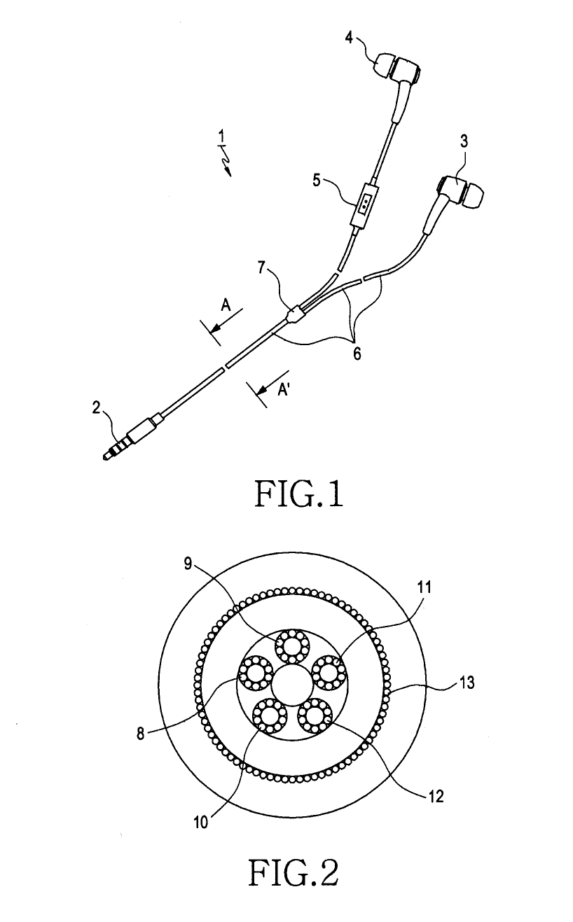

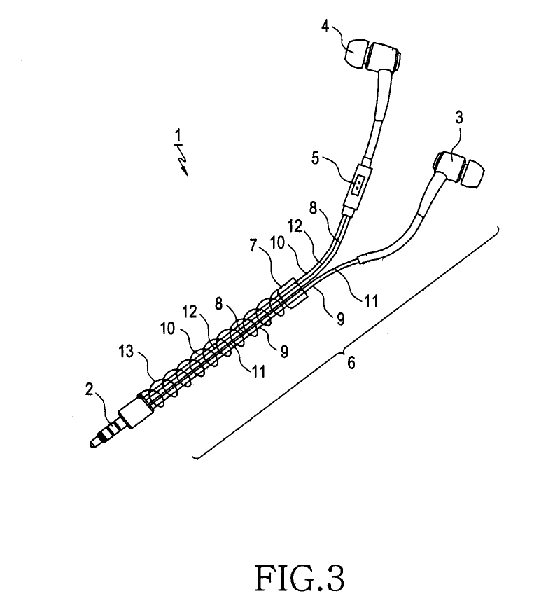

### DETAILED DESCRIPTION

Hereinafter, an exemplary embodiment of the present invention will be described with reference to the accompanying drawings. For the purposes of clarity and simplicity, well known structures or components will not be described as they obscure the subject matter of the present invention.

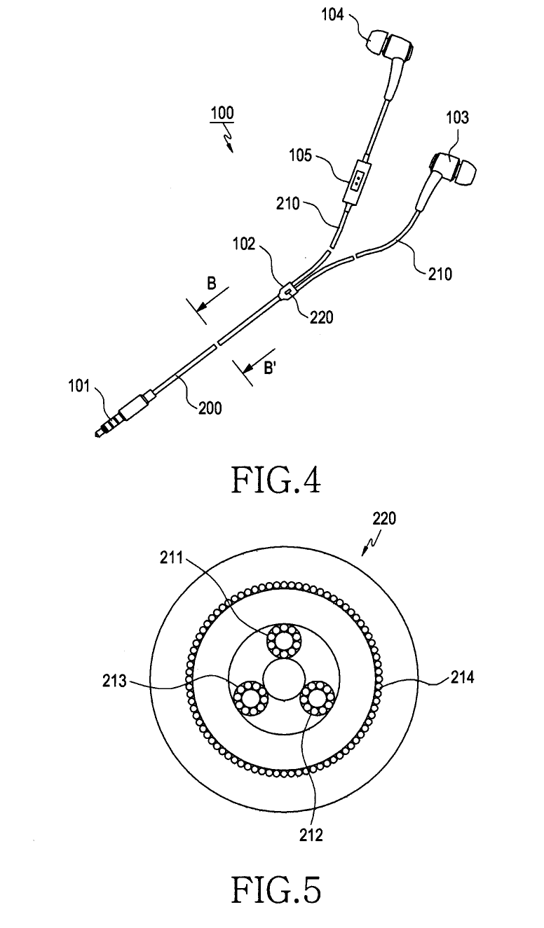

Referring to FIGS. 4 through 6, an earphone antenna device 100 according to an embodiment of the present invention may include an ear jack 101, a junction 102, left and right speaker phones 103 and 104, a microphone device 105, first and second cables 200 and 210, and a bead portion 220.

Herein, the ear jack 101 may be a 3.5Ø ear jack.

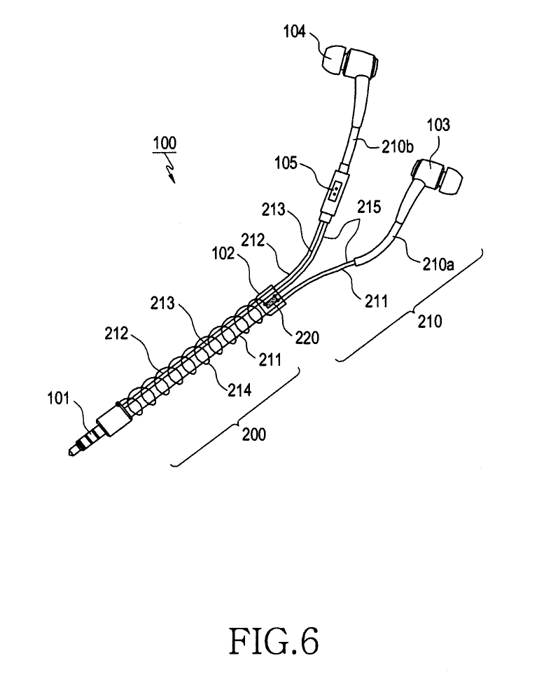

Referring to FIGS. 5 and 6, in this state, between the ear jack 101 and the junction 102 is provided a first cable 200 which has embedded therein an antenna line 214 having a function as the earth line. That is, the antenna line 214 serves to function as the earth line, thus eliminating the need of the conventional earth line. The earth line may be an earth line for an earphone signal, which will be referred to as an ‘earphone signal earth line’.

Referring to FIGS. 4 and 6, the first cable 200 has embedded therein left and right speaker lines 211 and 212, a microphone line 213, and the antenna line 214. An end of the antenna line 214 is soldered and electrically connected to the ear jack 101, and in this state, a central portion of the antenna line 214 is provided to surround the left and right speaker lines 211 and 212 and the microphone line 213. The other end of the antenna line 214 is soldered and electrically connected to the bead portion 220 provided in the junction 102.

Referring to FIG. 6, the bead portion 220 may be a board to be electrically connected to the antenna line 214 through soldering. In this state, the second cable 210 is provided between the junction 102 and the left and right speaker phone 103 and 104, and the second cable 210 includes first and second earphone cables 210a and 210b.

As illustrated in FIG. 6, the first earphone cable 210a has embedded therein the left speaker line 211 and an earphone signal earth line 215 for connection with the left speaker phone 103, and the second earphone cable 210b has embedded therein the right speaker line 212, the microphone 213, and the earphone signal earth line 215 for connection with the right speaker phone 104 and the microphone device 105. An end of the earphone signal earth line 215 of each of the first and second earphone cables 210a and 210b is electrically connected to the bead portion 220 by soldering; the other end thereof is electrically connected to the right speaker phone 104 and the microphone device 105 or the left speaker phone 103 by soldering.

The bead portion 220 may be a board to be electrically connected to the earphone signal earth line 215 by soldering.

As mentioned above, in the junction 102, the antenna line 214 provided in the first cable 200 is used in place of the earphone signal earth line 215, such that a conventional earth line is not required in the junction 102, thereby reducing noises, which have been generated between an antenna line and a conventional earphone signal earth line, and thus improving the antenna reception performance of the earphone antenna device 100.

The bead portion 220 has a high impedance value at a frequency higher than 100 MHzs, and thus may include a filtering unit for reducing noises. Consequently, the earphone antenna device 100 benefits from an improvement of about 3 dB in antenna reception performance.

Herein, the earphone signal earth lines 215 may include ground lines.

Referring to FIGS. 5 and 6, the earphone signal earth line 215 is not provided in the first cable 200, such that a conventional earphone signal earth line of a length corresponding to the first cable 200 is not necessary and thus a copper line used in the earth line 215 is not needed, thereby reducing the unit cost of manufacturing of a product. Moreover, the diameter of the first cable 200 is reduced, so that the first cable 200 is flexibly bent, thereby improving the wearing sense of the left and right speaker phones 103 and 104 and making it easy to receive the earphone antenna device 100 due to a small volume of the earphone antenna device 100.

In the foregoing description, a portable communication device has been used as a representative application for the earphone antenna device 100 according to an embodiment of the present invention. However, the teachings of the present invention are applicable to various other types of portable communication devices without being limited to the above-described example.

Examples of the portable communication device to which the earphone antenna device 100 can be applied may include not only mobile communication terminals operating according to communication protocols corresponding to various communication systems, but also any information communication apparatuses and multimedia apparatuses such as Portable Multimedia Players (PMPs), MP3 players, navigation systems, game consoles, notebooks, advertising boards, TVs, digital broadcasting players, Personal Digital Assistants (PDAs), Digital Multimedia Broadcasting (DMB) phones, smart phones, and so forth, and their application apparatuses.

It will be obvious to those of ordinary skill in the art that the earphone antenna device according to the present invention described above is not limited by the foregoing embodiment and drawings, and various substitutions, modifications, and changes can be made in terminals having various exterior shapes.

What is claimed is:

1. An earphone antenna device comprising an ear jack, a junction, left and right speaker phones, and a microphone device, the earphone antenna device further comprising:
a first cable provided between the ear jack and the junction to have embedded therein an antenna line;
a second cable provided between the junction and the left and right speaker phones to have embedded therein a plurality of earth lines; and
a bead portion embedded in the junction to electrically couple the antenna line and the earth lines.

2. The earphone antenna device of claim 1, wherein the ear jack comprises a 3.5Ø ear jack.

3. The earphone antenna device of claim 1, wherein the first cable comprises:
left and right speaker lines electrically coupled to the left and right speaker phones, respectively; and
a microphone line electrically coupled to the microphone device.

4. The earphone antenna device of claim 1, wherein the second cable comprises:
a first earphone cable having embedded therein a left speaker line and the earth line for an electrical coupling with the left speaker phone; and
a second earphone cable having embedded therein a right speaker line, the microphone line, and the earth line for coupling with the right speaker phone and the microphone device.

5. The earphone antenna device of claim 1, wherein the bead portion comprises a board for electrically coupling the antenna line and the earth lines through soldering.

6. The earphone antenna device of claim 1, wherein the bead portion has a high impedance value at a frequency higher than 100 MHz and comprises a filtering unit for reducing noises.

7. The earphone antenna device of claim 1, wherein an end of the antenna line is electrically coupled to the ear jack by soldering, and the other end thereof is electrically coupled to the bead portion by soldering.

8. The earphone antenna device of claim 1, wherein an end of each earth line is electrically coupled to the bead portion by soldering, and the other end thereof is electrically coupled to the left or right speaker phone by soldering.

9. The earphone antenna device of claim 1, wherein the earth lines comprise ground lines.

10. An earphone antenna device comprising:
a cable having embedded therein an antenna line in lieu of an earth line; and
a bead portion provided on the cable to electrically couple ground lines and the antenna line which are provided in the cable of the earphone antenna device.

11. The earphone antenna device of claim 10, wherein the cable comprises: a first earphone cable having a left speaker line embedded therein and a first earphone signal earth line for connection with a left speaker phone, and a second earphone cable having a right speaker line embedded therein and a second earphone signal earth line for connection with a right speaker phone.

12. The earphone antenna device of claim 10, wherein one ends of the first and the second earphone signal earth lines of the first and second earphone cables are electrically coupled to a bead respectively, and; the other ends thereof are electrically coupled to the right speaker phone and the left speaker phone respectively.

13. The earphone antenna device of claim 12, wherein the bead comprises a board for electrically coupling to the first and the second earphone signal earth lines by soldering.

14. The earphone antenna device of claim 12, wherein the bead has a high impedance value at a frequency higher than 100 MHzs and comprises a filtering unit for reducing noises.

15. The earphone antenna device of claim 1, wherein the earth lines comprise a ground line.

16. An earphone antenna device comprising, comprising:
a junction;
a first cable having an antenna line embedded therein and coupled to one end of the junction; and
a second cable provided having a plurality of earth lines embedded therein and coupled to the other end of the junction.

17. The earphone antenna device of claim 16, further comprising a bead portion embedded in the junction to electrically couple the antenna line and the plurality of earth lines.

18. The earphone antenna device of claim 17, wherein the bead portion has a high impedance value at a frequency higher than 100 MHzs and comprises a filtering unit for reducing noises.

19. The earphone antenna device of claim 16, wherein the second cable comprises: a first earphone cable having a left speaker line embedded therein and a first earphone signal earth line for connection with a left speaker phone, and a second earphone cable having a right speaker line embedded therein and a second earphone signal earth line for connection with a right speaker phone.

20. The earphone antenna device of claim 16, further comprising an ear jack coupled to one end of the first cable.
